(19) United States
(12) Patent Application Publication
(10) Pub. No.: US 2014/0266581 A1
(43) Pub. Date: Sep. 18, 2014

(54) MODULAR SMART LABEL DATA TRANSMISSION SYSTEMS FOR APPLIED END-USER OPTIMIZATION

(71) Applicant: Aquavit Pharmaceuticals, Inc., New York, NY (US)

(72) Inventors: Sobin Chang, New York, NY (US); Marcos Hung, Elmhurst, NY (US); Sean Clarke, Bronx, NY (US)

(73) Assignee: Aquavit Pharmaceuticals, Inc., New York, NY (US)

(21) Appl. No.: 14/212,415

(22) Filed: Mar. 14, 2014

Related U.S. Application Data
(60) Provisional application No. 61/792,624, filed on Mar. 15, 2013.
(60) Provisional application No. 61/792,970, filed on Mar. 15, 2013.
(60) Provisional application No. 61/794,558, filed on Mar. 15, 2013.
(60) Provisional application No. 61/794,274, filed on Mar. 15, 2013.
(60) Provisional application No. 61/793,946, filed on Mar. 15, 2013.
(60) Provisional application No. 61/792,246, filed on Mar. 15, 2013.
(60) Provisional application No. 61/790,912, filed on Mar. 15, 2013.
(60) Provisional application No. 61/790,469, filed on Mar. 15, 2013.

(51) Int. Cl. G06K 7/10

(52) U.S. Cl. CPC G06K 7/10009; G06K 2007/10504
USPC 340/5.8

(57) ABSTRACT

Disruption tolerant transmission of supply chain and end user data allows for both advanced safety assurances and enhanced personalized utility of medical devices in or near the clinical environment. The embodiment of this invention encompasses the application of disruption tolerant transmission smart labels to microneedle patches and other modular medical devices bearing obvious and or nonobvious patentable features.

### CROSS-REFERENCE

This application claims the benefit of U.S. Provisional Applications Nos. 61/792,624, filed Mar. 15, 2013; 61/792,970, filed Mar. 15, 2013; 61/794,558, filed Mar. 15, 2013; 61/794,274, filed Mar. 15, 2013; 61/793,946, filed Mar. 15, 2013; 61/792,246, filed Mar. 15, 2013; 61/790,912, filed Mar. 15, 2013; and 61/790,469, filed Mar. 15, 2013; the contents of which are incorporated by reference in their entireties.

### BACKGROUND OF THE INVENTION

Disruption tolerant transmission of supply chain and end user data, allows for both advanced safety assurances and enhanced personalized utility of medical devices in or near the clinical environment. The embodiment of this invention encompasses the application of disruption tolerant transmission smart labels to microneedle patches and other modular medical devices bearing obvious and or nonobvious patentable features.

Counterfeit medicines pose serious health problems for the intended user, thus traceability and authentication technologies are in need to protect the consumer. Our invention, comprised of a smart label data transmission cryptographic system which is employed such that regardless of the availability of network access, any consumer can detect and verify whether they are the intended subject and if not, the invention will be able to recognize counterfeit medicine by identifying anomalous data descriptors. Our invention integrates medicine tracking and packaging technologies that can prevent common problems associated with health data security risks.

Our invention addresses a system which composes software frontend and backend interfaces. The software can be custom programmed for both the device and individual patient, capable of stand-alone or modular operation, or operated together with a network to facilitate telemedicine, self-assisted, and machine-assisted diagnosis and/or treatment. Smart medical labels as well as other intelligent medical devices might also aggregate data to permit interaction with emergency responders without violating relevant regulations such as HIPAA. These medical devices may be prepared with custom compounding of substances including pharmaceuticals, adhesives, lubricants, and pharmaceutical or hormone impregnated plastics. These substances may be directly applied to the medical device, inside the invention, or they may be combined after dispensing, or may be used separately.

Our invention addresses a system which may consist of either or both hardware preparation and software preparation. Hardware preparation may include attachment of wires or accessories, cutting, etching and or the lithographic printing of customized parts. Such printing is not restricted to printing of ink, but includes other printing technologies such as printing of circuitry, films of metal, plastics, biological materials, and similar substances. The software preparation may include programming of the device, including programming customized for the individual patient. The invention is capable of stand-alone operation and may include custom compounding of substances including pharmaceuticals, adhesives, lubricants, pharmaceutical or hormone impregnated plastics.

Our invention addresses the application of a disruption tolerant transmission system which delivers superior personalized benefits and safety assurances for each individual. The said system, interfaces case based patient information, allowing the MD to first assess the condition of the patient then, based upon the prevailing data, provide a treatment package for the patient which contains a disruption tolerant smart label microchip and/or barcode. The microchip may be attached to any part of the packaging, and could potentially be a biodegradable entity, where the chip can be placed inside the injectable, on a patch product, or inside a pill.

Our invention further addresses an application which accommodates the processing of information from microchips, barcodes, and patient records whereby data entered into the server which leads to the formulation of new treatment packages are created and recommended for that particular patient. Most devices run common operating systems, and have updatable firmware and programming. These and other factors make them more vulnerable than previous generations to malware, mis-programming, and memory corruption. As more vital information is delivered into the server by the MD, it not only functions as passive storage, but is subsequently processed and over time serves as an interactive personalized longitudinal data architecture, allowing the server to intelligently produce a smart formulation for that particular patient's needs each time as needed.

Our invention enhances an application for patient related data analytics, supply usage, and logistical elements of clinical practice. There is an especially great benefit for epidemiology where due to privacy and security concerns, the sharing of data is either undesirable or illegal. Our invention permits utility of analytics over interactive data architecture not previously possible.

### SUMMARY OF THE INVENTION

Our invention confers cryptographic security to modular workflow systems such as in the clinical or supply chain environment. Application of disruption tolerant transmission networking platforms to the clinical or supply chain setting allows for stronger more efficient data transmission, thereby improving process management and furthering compliance objectives.

Our invention allows for the customization of personalized treatment strategies. Customized programming for the individual patient may enhance the application of combinatorial or stand-alone interventional operations, thereby introducing operational efficiencies to machine assisted diagnosis and/or treatment platforms such as the microneedle patch and therapeutic platform.

Our invention further supports a cryptographic disruption tolerant interface, which allows for the maintenance of sophisticated networking and data storage platforms, which, in turn, support the custom compounding of substances and other dosage formulation functions.

Our invention, as stated above supports a system whereby the end-user of medicines or medical devices is provided with a high assurance of the underlying identity and compendial properties through a cryptographic system that includes the physical ferrying of data in one or a combination of elements of the supply chain. In this environment it is the goal of the medicine producer to supply medicine to the medicine consumer with assurance as to provenance, non-expiry, and non-violation of environmental requirements. The use of a cryptographic system supports the verification of customer identity, compound identity as well as the early detection of supply subversion, and propagation of medicine assurance information for medicine which is not committed to a specific consumer.

Our invention further addresses the delivery of logistical benefits to data analytic objectives. Our platform allows for the direct utility of analytics over active data sets without compromising safety assurances in process management which may result from the illegal and or undesirable sharing of confidential patient data, supply usage, and logistical elements of clinical practice and other sensitive data archives.

### BRIEF DESCRIPTION OF THE DRAWING

FIG. 1 The embodiment herein addresses a scheme whereby the smart label cryptographic protocol detects and directs the efficient operation and prevention of supply chain subversion events further allowing for enhanced end user service optimization in customized medical devices.

### DETAILED DESCRIPTION OF THE INVENTION

The invention as described above supports a telemedicine ecosystem which consists of individual medicine bottles with embedded RFID transponders, boxes of small collections of such bottles in which each box has a microcontroller with contact based or range communication, together with infrastructure points such as WiFi hotspots and contactless short smartphones with cellular network access, and or medical devices involved in the consumption of the individual medicine bottles such as a compounding device.

The invention addresses the advantage of our smart medical labels and their overarching ability to communicate with external computational entities through one or more wireless or contact based information interchange protocols. When a smart medical label is in an environment in which communication is possible, the label checks with the network to find out if any updates are available. If updates are available, the label checks to make sure that the update is cryptographically assured to be authorized, and if so the label will update itself or permit updates by an appropriate external computational entity.

The invention addresses the operational advantage of novel medical informatics systems which integrate disruption tolerant systems where the physical movement of data is required in order to achieve utility in areas with damaged or weak infrastructure such as developing areas including rural areas of developed countries. In these cases the introduction of operational efficiencies through the utility of disruption tolerant transmission interfaces can be added at any point in the supply line and carried to other points in the supply line or to the end user.

The invention underscores a novel mechanism whereby raw source data is transmitted to a trusted third party computational entity. In another aspect the third party computational entity may be untrusted under a range of adversarial models such as honest but curious, global passive adversary, and global active adversary. After receiving the raw source data, the data aggregation entity performs a novel transformation on the data, and provides to the data consuming entity unique statistical information maximizing chosen utility while meeting the previously agreed upon constraints.

The invention further addresses the enhanced efficacy of a cryptographic protocol between the medicine container or microneedle patch and the medical device in such an event that the said devices have malware, are corrupt, and in some cases are programmed incorrectly. If any such errors are detected, the smart medicine container will refuse to authenticate itself to the device, and by that or other means make it impossible to use the medicine in a manner approved by the manufacturer. Therein our invention assures the safety of the patient and the diminished liability of the manufacturer. Our invention also ensures that the operating system and other updates are approved by the relevant authorities; a distinct advantage when specific machine states are FDA approved. Our invention additionally ensures that the medicine can only be used as labeled by an approved device that is not counterfeit. Our system uses a combination of Device Tied Functions, remote attestation, and trusted hardware technology together with symmetric and asymmetric cryptologic methods.

What is claimed is:

1. A smart label, tag or microchip, microneedles, microneedle patches comprised of one or more layers of electronics, embedding a data transmission and receiver mechanism such as but not limited to an antenna, RFID, bluetooth, or wireless system.

2. The application of claim 1 to track, organize, administer, and avoid counterfeit medicine.

3. The application of claim 1 to track inventory, packaging, distribution and supply chain logistics in the commercialization of claim 2.

4. A system to read, transfer, and collect this data gathered in claim 1 into a computer system or database that is encrypted specific to the medication or patient using the smart label in claim 1.

5. A backend software that collects and analyzes claim 1 to be used for improvements/modifications to the supply chain logistics in claim 3 and for personalized medicine.

6. A frontend software or interface that interacts with the user, patient, or consumer to gather data for analysis.

7. A central location where artificial intelligence, data mining, and analytics providing new formulations, methods, or recommendations to facilitate personalized medicine and telemedicine.

8. The application of claim 6. to create a system for telemedicine, serving as a platform for remote, self-assisted, or machine assisted diagnosis and/or treatment, as reflected in FIG. 1.

9. A smart label, tag or microchip, microneedles, microneedle patches comprised of one or more layers of electronics, embedding a data transmission to apply and/or deliver treatments.

10. A multipurpose smart label in a form of a patch, including direct topical treatments or array of various microneedles, hollow, solid, or threaded, where the adhesive part is replaced with smart label.
